(19) United States
(12) Patent Application Publication
(10) Pub. No.: US 2014/0236790 A1
(43) Pub. Date: Aug. 21, 2014

(54) FINANCIAL RECORD MODIFICATION

(71) Applicant: BANK OF AMERICA CORPORATION, Charlotte, NC (US)

(72) Inventors: Michael Gerald Smith, Fort Mill, SC (US); Timmy L. Gauvin, Peachtree City, GA (US); Craig David Palmer, Mint Hill, NC (US); Eric Scott Sandoz, Concord, CA (US); Geoffrey Reed Williams, Midlothian, TX (US)

(73) Assignee: BANK OF AMERICA CORPORATION, Charlotte, NC (US)

(21) Appl. No.: 13/768,245

(22) Filed: Feb. 15, 2013

(51) Int. Cl. G06Q 40/00

(52) U.S. Cl. CPC G06Q 40/00
USPC 705/35

(57) ABSTRACT

Embodiments for modifying financial record data, such as check images, are provided herein. The embodiments include receiving financial record data; identifying one or more criteria associated with the financial record data; quantifying the size of the one or more criteria; modifying at least a portion of the financial record data based on size of the one or more criteria; and providing at least a portion of the received financial record data or modified financial record data to a recipient.

### BACKGROUND

Financial institutions may sometimes receive large quantities of financial records such as checks, contracts, or loan documents. The financial institutions may be required to save these records for a certain period of time due to regulations or policies, and may be further required to process these records. Due to the varied period of time that the financial records are stored, the many different types of financial records and associated processing, and the large volume of records, organizing and analyzing the financial records can be difficult.

### BRIEF SUMMARY

The embodiments provided herein are directed to a system for modifying financial records. In some embodiments, the system includes a computer apparatus including a processor and a memory; and a modification software module stored in the memory, comprising executable instructions that when executed by the processor cause the processor to receive financial record data. In some embodiments, the module is further configured to identify one or more criteria associated with the financial record data. In some embodiments, the module is further configured to quantify the size of the one or more criteria. In some embodiments, the module is further configured to modify at least a portion of the financial record data based on size of the one or more criteria. In some embodiments, the module is further configured to store at least one of the received financial record data and one or more modified portions of the financial record data in a storage device. In some embodiments, the module is further configured to provide at least a portion of the received financial record data or modified financial record data to a recipient.

In other embodiments of the systems, the received financial record data comprises at least one of a financial record image and a financial record, wherein the financial record comprises a paper record. In still other embodiments, the modification comprises modification to a front portion of the financial record or the back portion of the financial record. In further embodiments, the module is further configured to capture one or more images of the financial record and one or more images of the one or more modified portions. In still further embodiments, the module is further configured to overlay the financial record image with the one or more modified images.

In additional embodiments of the system, the module is further configured to remove the one or more modified images from the received financial record image. In other embodiments, the one or more criteria comprises at least one of errors, repairs, updates, and amendments. In some embodiments, the size of the one or more criteria comprises a total number or a quality level of the errors, the repairs, the updates, or the amendments. In other embodiments, the module is further configured to add or remove at least a portion of the financial record data. In further embodiments, the module is further configured to receive a financial record request; and remodify at least one of the received financial record data and the one or more modified portions of the financial record data based on the financial record request. In still further embodiments, the financial record comprises a check. In some embodiments, the modification comprises at least one of a physical modification to a paper record and an electronic modification to electronic data.

Also provided herein, are embodiments directed to a computer program product for modifying financial records. In some embodiments, the computer program product includes a computer readable storage medium having computer readable program code embodied therewith. In some embodiments, computer readable program code is configured to receive financial record data. In some embodiments, computer readable program code is configured to identify one or more criteria associated with the financial record data. In some embodiments, computer readable program code is configured to quantify the size of the one or more criteria. In some embodiments, computer readable program code is configured to modify at least a portion of the financial record data based on the size of the one or more criteria. In some embodiments, computer readable program code is configured to store at least one of the received financial record data and one or more modified portions of the financial record data in a storage device. In other embodiments of the computer program product, computer readable program code configured to provide at least a portion of the received financial record data or modified financial record data to a recipient.

In some embodiments of the computer program product, the received financial record data comprises at least one of a financial record image and a financial record, wherein the financial record comprises a paper record. In other embodiments, computer readable program code is configured to store at least one of the received financial record data and one or more modified portions of the financial record data in a storage device. In still other embodiments, computer program code is configured to capture one or more images of the financial record and one or more images of the one or more modified portions. In further embodiments, computer program code is configured to overlay the financial record image with the one or more modified images. In still further embodiments, the one or more criteria comprises at least one error, repair, update, and amendment.

Further provided herein are computer-implemented methods for modifying financial records. In some embodiments of the methods, the methods include receiving, at a computing device, financial record data. In some embodiments, the methods include identifying, by a computing device processor, one or more criteria associated with the financial record data. In some embodiments, the methods include quantifying, by a computing device processor, the size of the one or more criteria. In some embodiments, the methods include modifying, by a computing device processor, at least a portion of the financial record data based on size of the one or more criteria. In some embodiments, the methods include storing, by a computing device processor, at least one of the received financial record data and one or more modified portions of the financial record data in a storage device. In some embodiments, the methods include providing at least a portion of the received financial record data or modified financial record data to a recipient.

In other embodiments of the methods, the one or more criteria comprises at least one error, repair, update, and amendment. In still other embodiments, the size of the one or more criteria comprises a total number or a quality level of the at least one error, the at least one repair, the at least one update, or the at least one amendment. In additional embodiments, the methods include receiving a financial record request. In still additional embodiments, the methods include remodifying, by a computing device processor, at least one of the received financial record data and the one or more modified portions of the financial record data based on the financial record request.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 provides a block diagram illustrating a system and environment for modifying financial records;

FIG. 2 provides a block diagram illustrating the financial institution system, the merchant system, and the user capture device of FIG. 1, in accordance with various embodiments;

FIG. 3 is a flowchart illustrating a system and method for modifying financial records in accordance with various embodiments;

FIG. 4 is a flowchart illustrating a system and method for modifying financial records in accordance with various embodiments;

FIG. 5 is a flowchart illustrating a system and method for modifying financial records in accordance with various embodiments;

FIG. 6 illustrates an exemplary image of a financial record in accordance with various embodiments;

FIG. 7 illustrates an exemplary database containing financial record data in accordance with various embodiments; and

FIG. 8 illustrates an exemplary image of a financial record in accordance with various embodiments.

### DETAILED DESCRIPTION

The embodiments presented herein are directed to systems, methods, and computer program products for modifying financial records and providing financial records to various recipients. In some embodiments, a financial record is altered or otherwise modified, and the modifications are reassessed to determine if the modification should be removed or if additional modification should be added. In particular embodiments, previous modification made to a financial record image are removed such that the original received financial record image is presented to a recipient. In this way, original financial record data may be provided even after modification are made to the record in accordance with some legal requirements, and the need for storage space may reduced.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As presented herein, embodiments that modify, analyze, process, archive, and distribute financial records are provided. As used herein, the term “financial record” refers to, but is not limited to records associated with financial record data, account data, government data, legal data, identification data, and the like. Exemplary financial records include legal documents, wills, court papers, legal memorandum, leases, birth certificates, checks, receipts, contracts, loan documents, financial statements, bills, and the like. Although the disclosure is directed to financial records, it will be understood that non-financial records such as social communications, advertising, blogs, opinion writing, and the like may also be applicable to the disclosure presented herein. In cases were non-financial records are use, it will be understood that personal information, such personal identifying information, account numbers, and the like, can be removed from the documents before they are released. For example, if a coupon or product review is to be used in advertising, personal information associated with such records will be removed before the advertising is presented to the public. The data of the financial records or non-financial records may be provided in a wide variety formats including, paper records, electronic or digital records, video records, audio records, and/or combinations thereof.

Additionally, the present disclosure includes check imaging technology with a purpose of saving storage space in the archive of an entity (e.g., a financial institution). Currently, an entity's check imaging system may receive an image of a check at a high resolution (200 dots per inch (DPI)) and may store the image in the archive at this resolution for a mandated period of seven years. However, regulations may not require that the archived image be of this high resolution. To save storage space in the archive, the present disclosure may capture pieces of the check information by processing the image of the check and then store the various pieces of the check information as either text or smaller high resolution (or low resolution) images. The pieces of check information may then be retrieved individually or in bulk by an apparatus to generate a second image of the check. Furthermore, the present disclosure may create a thumbnail version of the image of the check at a lower resolution and store said thumbnail version of the image of the check in the archive for seven years in lieu of storing the high resolution image of the check.

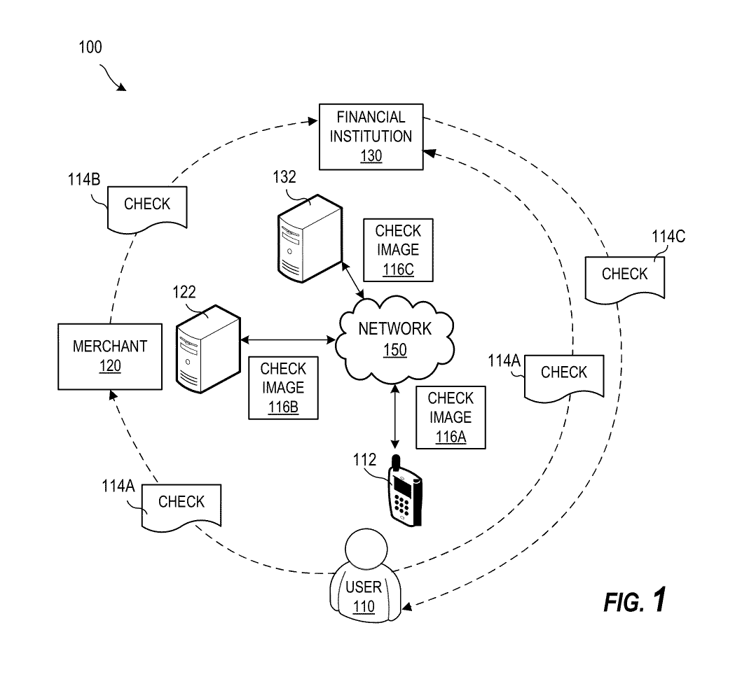

Referring now to the figures, FIG. 1 provides a block diagram illustrating a system and environment 100 for modifying and distributing financial records. The system 100 includes a user 110, a merchant 120, and a financial institution 130. In some embodiments, a user includes an individual or entity associated with a financial record. For example, the user includes account holders, entities authorized to write checks or contribute to the financial record, financial institution customers, merchant customers, purchasers, parties to the financial record, and the like. In the illustrated embodiment, the user 110 is an account holder who issues a paper check 114A. Although a paper check and check image are illustrated in FIG. 1, it will be understood that any financial record or format of a financial record may be used. Also included in the environment 100 is a capture device 112 of the user 110, a merchant system 122, and a financial institution system 132, which are operably connected via a network 150.

As shown in FIG. 1, the user 110 uses the capture device 112 to capture an image of the check 114A to produce check image 116A. In the illustrated embodiment, the capture device 112 is a mobile device such as smart phone that includes a camera. It will be understood, however, that the capture device 112 can include any type or number of devices for capturing images or converting the check 114A to any type of electronic format such as a camera, personal computer, lap top, notebook, and/or other device. In some exemplary embodiments, the user 110 takes a picture of the check 114A at a point of sales or an automated teller machine (ATM) and communicates the resulting check image 116A to a point of sales device or ATM via wireless technologies, near field communication (NFC), radio frequency identification (RFID), and other technologies. In other examples, the user 110 uploads or otherwise sends the check image 116A to the merchant via email, short messaging service (SMS) text, a web portal, online account, mobile applications, and the like. For example, the user 110 may upload a check image to deposit funds into an account or pay a bill via a mobile banking application using the capture device 112.

The user 110, as further illustrated in FIG. 1, uses the capture device 112 to send the check image 116A to the merchant system 122 and/or the financial institution system 132. The merchant system 122, in some embodiments, modifies the check image 116A to produce check image 116B. For example, the merchant may modify the check image to include an endorsement, a merchant category code, a time stamp, formatting changes, file conversions, and the like. In other embodiments, the check image 116A is not modified or modifications are removed such that the check image 116B is the same as or substantially similar to the check image 116A. The merchant system 122, in still further embodiments, provides the check image 116B to the financial institution system 132.

In some embodiments, the financial institution system 132 modifies the check image 116A or check image 116B to produce check image 116C. In other embodiments, the check image 116A or the check image 116B is not modified or modifications are removed such that the check image 116C is the same as or substantially similar to check image 116A or check image 116B. In further embodiments, the financial institution system 132 provides check image 116C to the capture device 112 or some other device associated with the user 110.

In additional or alternative embodiments, the user 110 provides the check 114A to the merchant 120 or the financial institution 130. For example, if the user 110 is making a payment to the merchant 120, the user 110 may write the check 114A and hand the check 114A over to the merchant 120. In another example, the user 110 may deposit the check 114A at an automated teller machine (ATM) associated with the financial institution 130 or give the check 114A to a teller at the financial institution 130.

Once the merchant 120 receives the check 114A, the merchant 120 can modify the check 114A to produce a check 114B. For example, the check 114B may include an endorsement, time stamp, code, and the like printed on the check 114A. In other embodiments, the check 114A is not modified such that the check 114B is the same as the check 114A. In still other embodiments, the merchant system 122 captures one or more image of the received check 114A and/or the check 114B that includes modifications, and processes such images as described herein. In further embodiments, the check 114B is provided to the financial institution 130. For example, the merchant 120 may provide the check 114B to the financial institution 130 such that money from the account of user 110 can be transferred to the merchant 120.

In still further embodiments, the financial institution 130 provides a check 114C to the user 110. The check 114C may be, for example a modification of check 114B or the same as the check 114B. In other embodiments, the check 114C is the same or different as the check 114A. For example, the financial institution 130 may choose to modify or not modify the check 114A received from the user 110. In still other embodiments, the financial institution system 132 captures one or more image of the received check 114A or 114B and/or the check 114A or the check 114B that each includes modifications, and processes such images as described herein.

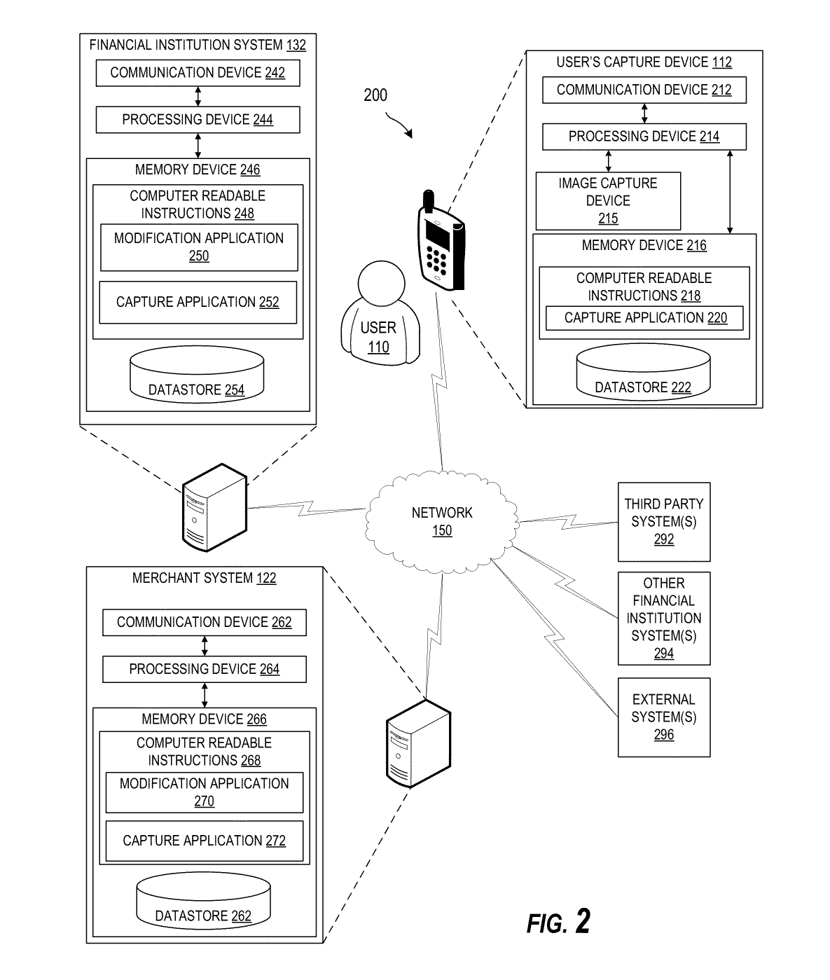

Referring now to FIG. 2, a block diagram illustrates an environment 200 for modifying financial records. The environment 200 includes the capture device 112, the merchant system 122, and the financial institution system 132 of FIG. 1. The environment 200 further includes one or more third party systems 292 (e.g., a partner, agent, or contractor associated with the merchant 120 and/or the financial institution 130), one or more other financial institution systems 294 (e.g., a credit bureau, third party banks, and so forth), and one or more external systems 296. The systems and devices communicate with one another over the network 150 and perform one or more of the various steps and/or methods according to embodiments of the disclosure discussed herein. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

The capture device 112, the merchant system 122, and the financial institution system 132 each includes a computer system, server, multiple computer systems and/or servers or the like. The financial institution system 132, in the embodiments shown has a communication device 242 and an image capture device (not shown) communicably coupled with a processing device 244, which is also communicably coupled with a memory device 246. The processing device 244 is configured to control the communication device 242 such that the financial institution system 132 communicates across the network 150 with one or more other systems. The processing device 244 is also configured to access the memory device 246 in order to read the computer readable instructions 248, which in some embodiments includes a modification application 250 and a capture application 252. The memory device 246 also includes a datastore 254 or database for storing pieces of data that can be accessed by the processing device 244.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

The user's capture device 112 includes a communication device 212 and a image capture device 215 (e.g., a camera) communicably coupled with a processing device 214, which is also communicably coupled with a memory device 216. The processing device 214 is configured to control the communication device 212 such that the user's capture device 112 communicates across the network 150 with one or more other systems. The processing device 214 is also configured to access the memory device 216 in order to read the computer readable instructions 218, which in some embodiments includes a capture application 220. The memory device 216 also includes a datastore 222 or database for storing pieces of data that can be accessed by the processing device 214.

The merchant system 122 includes a communication device 262 and an image capture device (not shown) communicably coupled with a processing device 264, which is also communicably coupled with a memory device 266. The processing device 264 is configured to control the communication device 262 such that the merchant system 122 communicates across the network 150 with one or more other systems. The processing device 264 is also configured to access the memory device 266 in order to read the computer readable instructions 268, which in some embodiments includes a modification application 270 and a capture application 272. The memory device 266 also includes a datastore 262 or database for storing pieces of data that can be accessed by the processing device 264.

In some embodiments, the capture application 220, the modification application 270, and the capture application 272 interacts with the modification application 250 to receive or provide financial record data, modify financial record data, and analyze financial record data.

The applications 220, 250, 270 and 272 are for instructing the processing devices 214, 244 and 264 to perform various steps of the methods discussed herein, and/or other steps and/or similar steps. In various embodiments, one or more of the applications 220, 250, 270 and 272 are included in the computer readable instructions stored in a memory device of one or more systems or devices other than the systems 122 and 132 and the user's capture device 112. For example, in some embodiments, the application 220 is stored and configured for being accessed by a processing device of one or more third party systems 292 connected to the network 150. In various embodiments, the applications 220, 250, 270 and 272 stored and executed by different systems/devices are different. In some embodiments, the applications 220, 250, 270 and 272 stored and executed by different systems may be similar and may be configured to communicate with one another, and in some embodiments, the applications 220, 250, 270 and 272 may be considered to be working together as a singular application despite being stored and executed on different systems.

In various embodiments, one of the systems discussed above, such as the financial institution system 132, is more than one system and the various components of the system are not collocated, and in various embodiments, there are multiple components performing the functions indicated herein as a single device. For example, in one embodiment, multiple processing devices perform the functions of the processing device 244 of the financial institution system 132 described herein. In various embodiments, the financial institution system 132 includes one or more of the external systems 296 and/or any other system or component used in conjunction with or to perform any of the method steps discussed herein. For example, the financial institution system 132 may include a financial institution system, a credit agency system, and the like.

In various embodiments, the financial institution system 132, the merchant system 122, and the user's capture device 112 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 300, the other methods discussed below, or other methods, processes or steps discussed herein or not discussed herein.

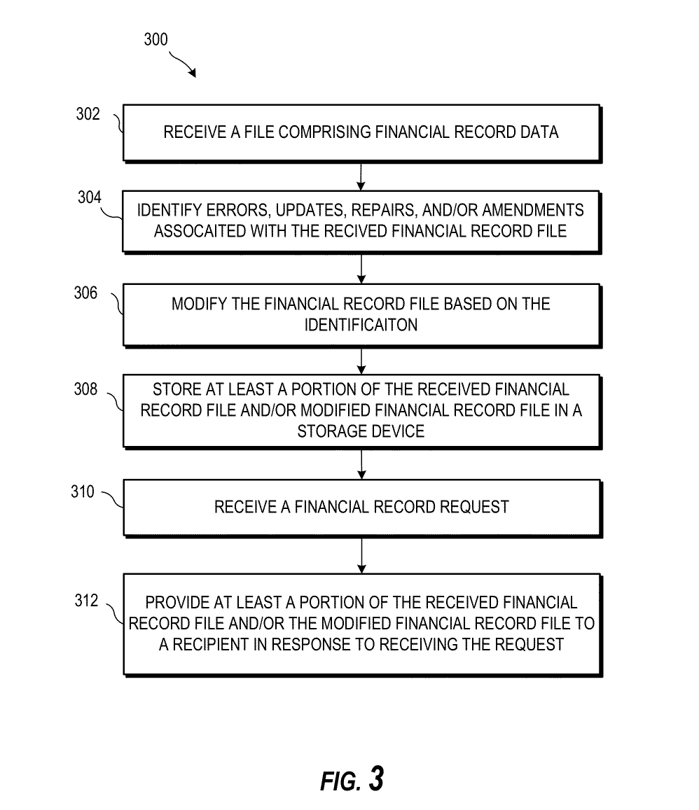

FIG. 3 illustrates a flowchart providing an overview of a process 300 for modifying financial records. One or more devices, such as the one or more capture devices and/or one or more other computing devices and/or servers of FIG. 1 and FIG. 2, can be configured to perform one or more steps of the process 300, or process 400, or process 500 described below. In some embodiments, the one or more devices performing the steps are associated with a financial institution. In other embodiments, the one or more devices performing the steps are associated with a merchant, business, partner, third party, credit agency, and/or user.

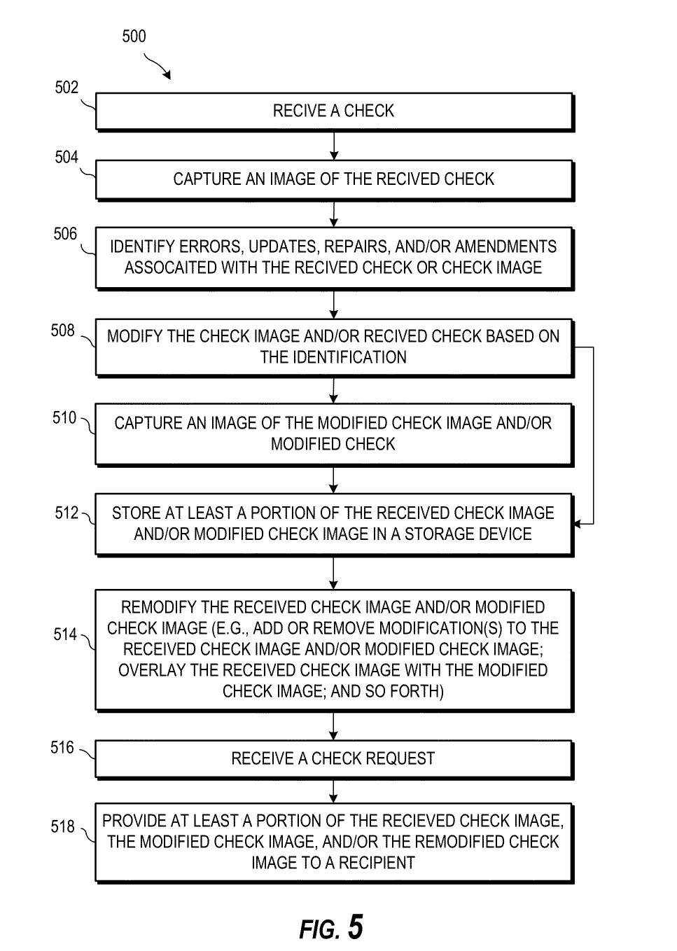

As illustrated at block 302, a file comprising financial record data is received. At least a portion of the financial record data, in some embodiments, is received from a financial institution, a merchant, a signatory of the financial record (e.g., the entity having authority to endorse or issue the financial record), and/or a party to the financial record. The file includes a collection of data in any type of format, including text file formats, portable document formats, audio file formats, image file formats, video file formats, graphic file formats, presentation formats, spreadsheet formats, combinations thereof, and the like. The financial record data includes dates of issuance of financial record, terms of the financial record, time period that the financial record is in effect, identification of parties associated with the financial record, payee information, payor information, obligations of parties to a contract, purchase amount, loan amount, consideration for a contract, representations and warranties, product return policies, product descriptions, check numbers, document identifiers, account numbers, merchant codes, file identifiers, source identifiers, and the like. Although the illustrated embodiment of FIG. 3 is directed to a financial record file that includes electronic data, it will be understood that the financial record (e.g., a paper document) may also be received as discussed below with regard to FIG. 5.

As illustrated at block 304, errors, updates, repairs, and/or amendments associated with the received financial record file are identified. The errors include errors associated with the financial record data such as account numbers, routing numbers, addresses, party identifications, addresses, terms of the financial record, metadata, image quality, document quality, text quality, and the like. Exemplary errors include misplacements of portions of the financial record data, blank spaces, typos, missing data, incorrect account or routing numbers, file errors, and the like. For example, a signature may not be on the correct line, references may include typos, and the page numbering may be incorrect.

The updates are associated with portions of the financial record data that are outdated or missing. For example, certain terms of the financial record may be missing because such terms were not known at the time the financial record data was received such as the date of birth or an unborn person, the date of death of a living person, marriage dates, divorce dates, forthcoming loan amounts, the names of the parties to the financial records, changing interest rates, policy changes, and the like. In other examples, some portions of the financial record data is not missing but is incorrect because the data is out of date such as reissued account numbers, fluctuating interest rates, increases or decreases in loan amounts, increased or decreases in purchase amounts, paid amount adjustments, names of parities to the financial record, expiring terms or stipulations of the financial record, and the like.

The repairs include the portions of the financial record file that need adjustment, correction, or enhancement. The repairs relate to, in some embodiments, malfunctioning hyperlinks, program errors, metadata, microprinting (e.g., check microlines), financial record security features, file encryption, poor image quality, and the like.

The amendments include additional data that can be added to the financial record file. Exemplary amendments include addendums to the financial record, additional terms, and the like. The amendments, in some embodiments, are associated with specific portions of the financial record data. For example, the amendment may include filling in a blank line, adding additional terms to sentences or segments of the financial record, and the like. In additional or alternative embodiments, the amendments are separate from the financial record. For example, the amendment may include any additional record associated with the financial record such as supporting documents, an additional page to a contract, an attached receipt for a paid bill, proof of domicile, proof of insurance, identification documents, and the like.

As illustrated at block 306, the financial record file is modified based on the identification. The modification includes any changes or corrections to the financial record file that are associated with the errors, updates, repairs, and/or amendment discussed above. Exemplary modification include any changes related to metadata, font type, font size, image quality, text quality, color, image size, document size, margins, text or line spacing, page layouts, page setups, file names, financial record data errors, financial record data updates, deletion of at least a portion of the financial record data, additions to at least a portion of the financial record data, data compatibility, and the like.

The modification, in some embodiments, includes electronic changes to the financial record file and/or physical changes to the financial record itself. In other embodiments, the modification is made to all sides of the financial record or financial record file. For example, physical or electronic modifications may be made to the front portion of a paper check or check image and/or to the back of the paper check or check image. In other examples, the modification may be made to the side portions of the financial record in cases where the financial record comprises multiple rectangular pages that form a stack of pages, where the one or more side portions of the stack have a sufficient amount of area to include information. Although a single piece of paper may be too thin to include information on the sides of the check (i.e., only the front and back areas of the paper may include information), a stack of pages may have sufficient width to include data. For example, text or numbers (e.g., an ID number) may be printed on one the one or more sides of the stack of pages, or if the financial record is contained in a box or binder, all sides of the box or binder may include text or numbers. In such cases, electronic and/or physical modification may be made to the front area, the back area, and the side portion areas of the financial record and/or financial record file.

In exemplary embodiments, the modification includes the addition of an endorsement to the financial record file or the financial record. For example, the endorsement may be physically or digitally added to the back of a check or to the image of the back portion of the check. In further embodiments, additional pages that are separate from the original financial record or received financial record file are included in the modification. Exemplary additional pages include, for example, addendums, cover sheets, listings of modifications to the received financial record file or financial record data, related documents, supporting documents, and the like.

In some embodiments, at least some of the detected errors, updates, repairs, and/or amendments are not modified. For example, mistakes made by adverse parties may be preserved for the benefit of an account holder. In other examples, certain aspects of the financial record may be preserved for legal reasons or certain filings may be incapable of correction according to the law. For instance, if a filing date is missed or if the financial record is missing data, such oversight may not be later corrected under certain law. In additional examples, only modifications that affect the rights of parties associated with the financial record, or that are important are undertaken. If a portion of the file record is slightly blurry and still legible, the quality of the financial record file may not be corrected in some instances. In other instances, grammatical errors, misspellings, other typos that do not affect the rights of the parties to the financial record or that do not render the financial record unclear may not be corrected.

In further embodiments, the number of detected errors, updates, repairs and/or amendments is quantified. Based at least in part on the quantified number, the system of process 300 determines that a modification should or should not be implemented. For example, if the total number of repairs detected for a particular financial record file is above a certain number, then at least one modification is implemented to address at least one of the detected repairs. In other embodiments, a level of the quality of the financial record file is calculated to determine that the modification should or should not be implemented. A determination that the modification should or should not be made or the identity of the modification may be based at least in part on predetermined levels such as color saturation, number of pixels, text size, line spacing, or contrast.

In still other embodiments, trends in the types and frequencies of modifications associated with records that are similar, related, or dissimilar to the financial record file are determined. Based at least in part on the determination, a determination that the modification should or should not be made or the identity of the modification is made. For example, the system of process 300 may compare check images associated with a current time period with check images associated with a previous time period to determine if the modifications of the previous check images should be applied to the current check images. If the current and previous check images have the same types of merchant payees, are associated with the same types of transactions (automatic bill pay, deposits, and so forth), have similar ranges of paid amounts, occur during similar time periods (e.g., tax season, holiday season, and so forth), have the same types of accounts (e.g., checking accounts), are associated with accounts that have balances within a certain range (e.g., accounts that have balances over $5,000), or combinations thereof, the modifications made to the previous check images can also be applied to the current check images.

In other cases, financial records that are similar or dissimilar may be compared. For example, modifications made to documents for proceedings in which a secured party has executed on collateral due to nonpayment may be compared to modifications of records related to wills to determine if there is any overlap in the types and frequency of modifications made to the different types of financial records or to determine if modification made in one type of financial record should be applied to other types of financial records. The system of process 300 may determine, for example, that all or some financial records should be stored as the same type of file format (e.g, all should be PDFs, image files, compress files), same resolution range, or same file size range based on the comparison of the dissimilar record data. Additionally, the system of process 300 may determine, for example, that all or some financial records should be modified to include an internal tracking code based on the comparison of the dissimilar record data. In this way, at least some modifications to the financial records can be standardized and uniformly applied.

In other examples, the modifications to one type of financial record may not be used in other types of financial records. For example, converting handwritten portions of a contract to printed text for ease of reading and clarity may be unwanted or disallowed in other financial records such as wills or checks. In still other examples, downgrading the resolution quality of an image file to increase storage capacity may be acceptable for checks that have both printed and handwritten portions, but unacceptable for other records such as a contract that is entirely handwritten or records that contain fine lines or great detail. In further embodiments, information from one record is included in the modification to another record. For example, certain terms, identifications, account numbers, and other record data of one financial record may be included in another record by cross referencing the records. If a loan record for a proceeding in which a secured party has executed on collateral due to nonpayment is missing the middle initial of a party to the loan, for example, then a check of that party may be identified by matching account numbers, names, or other data, and certain data, such as the missing middle initial, in the identified check may be included in the loan record during modification.

As illustrated at block 308, at least a portion of the received financial record file and/or modified financial record file is stored in a storage device (e.g., the datastores 254 of FIG. 2). The entire original received financial record file and/or the entire modified financial record file may be stored or only portions of the received financial record file and/or the modified financial record file is stored. It can be beneficial, in some instances to save the entire or at least a portion of the received financial record file for cases in which legal requirements require that the original received financial record be maintained. In further instances, the amount paid and the identity of the payee and payor may be the only information of interest such that all other information related to the financial record (such as the date of execution and account numbers) are discarded. If the financial record file is an image or an electronic document, for example, the file may be cropped, reformatted, or the like to extract one or more targeted portions of the financial record file. The one or more extracted targeted portions of the received financial record file and/or modified financial record file may be stored in a single file or in multiple files.

In still other embodiments, each modification of the modified financial record file is stored. For example, text, numbers, or graphics applied to or overlaid on the received financial record file to create the modified financial record file is stored separately from the modified financial record file. For example, a modification template file, e.g., a micro line or endorsement template that is included in a modified financial record file may be saved separately from the modified financial record file. Because the modification template file may only be a string of text or numbers, it typically includes less data than a modified financial record file. Instead of using up a large amount of space for various versions of a modified financial record file, the modification templates and only the latest version or the completed version of the modified financial record file may be stored. In cases where a modification is later removed, the modification may be replaced by overlaying the modification on a financial record.

As illustrated at block 310, a financial record request is received. The request includes, in some embodiments, the identity of the requester, the identity of the intended recipient, an indication of the portion of the received financial record file and/or modified financial record file that is requested, the format of the received financial record file and/or modified financial record file, additional modifications to be made to the received financial record file and/or modified financial record file, and/or the transmittal method for sending the requested data. In some embodiments, the financial record request is received from a merchant, a party to the financial record, an account holder associated with the financial record, a third party, a financial institution, a government entity, combinations thereof, and the like. The requester and recipient can be the same or different. For example, an account holder may request the financial record on behalf of a third party financial institution or vice versa.

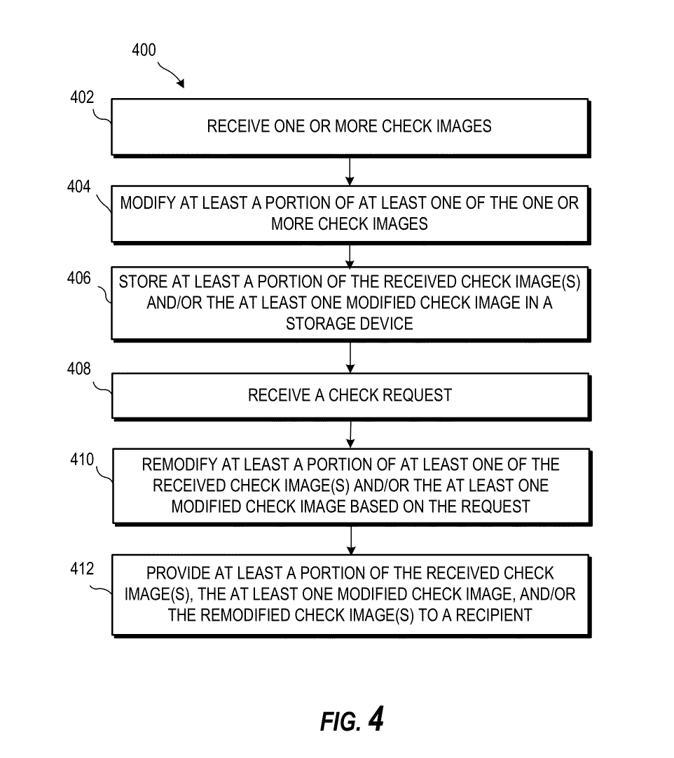

As illustrated at block 312, at least a portion of the received financial record file and/or the modified financial record file is provided to a recipient in response to receiving the request. For example, the recipient may be provided with the entire received financial record file and/or the entire modified financial record file. In other examples, only a portion of the received financial record file and/or modified financial record file is provided to the recipient. For example, if a joint checking account holder wishes to determine the identity of the person who wrote a specific check, the account holder need only view the payee name or amount. Based on the handwriting of the payee name, for example, the requesting account holder can determine which joint account holder authorized the check. Further, requesters can also determine, based on the handwriting, if the person who signs a check or other financial record is an authorized party in order to stop or allow payment, or determine if an account has been compromised. The recipient includes, for example, a merchant, a party to the financial record, an account holder associated with the financial record, a third party, a financial institution, a government entity, combinations thereof, and the like. The requested portion of the received financial record file and/or the modified financial record file can be provided via a mobile application on the recipient's device (e.g., a mobile device or a computing device), email, text, online banking account, or any other method. For example, a user of a mobile device may send the financial record request using a mobile application operating on the user's mobile device, and receive and download the provided financial record files. The embodiments of process 300 are further incorporated in the processes of FIGS. 4-5.

Referring now to FIG. 4, a process 400 for modifying financial records is illustrated in accordance with some embodiments of the disclosure. As illustrated at block 402, one or more check images are received. Although the illustrated embodiment is directed to checks, it will be understood that any type of financial record can be used in the process 400. The one or more check images are received, in some embodiments, from at least one of an account holder, the person authorized to sign the checks, a financial institution, a merchant, a party associated with the checks, a payee, and a payor. In additional embodiments, the one or more check images are associated with one or more different checks or a single check. For example, the one or more check images may include at least one image of the front of the one or more checks and at least one image of the back of the one or more checks.

As illustrated at block 404, at least a portion of at least one of the one or more check images is modified. As described in more detail above, the modification can be determined based on any number of factors including detected errors, updates, and the like. As described hereinabove with regard to FIG. 3, the modification includes any number of modifications. As illustrated at block 406, at least a portion of the received one or more check images and/or the at least one modified check image is stored in a storage device.

As illustrated at block 408, a check request is received. As described above, the request includes, inter alia, an indication of the portion of the received financial record file and/or modified financial record file that is requested, the format of the received financial record file and/or modified financial record file, and/or additional modifications to be made to the received financial record file and/or modified financial record file. In some embodiments, the check request is received from a merchant, a party to the financial record, an account holder associated with the financial record, a third party, a financial institution, a government entity, combinations thereof, and the like.

As illustrated at block 410, at least a portion of at least one or the received one or more check images and/or the at least one modified check image is remodified based on the request. In some embodiments, the remodification includes one or more modifications to a financial record that are made subsequent to a first set of one or more modifications (e.g., the modification made in block 404). For example, if the check request indicates that only a portion of the received check image and/or the modified check image is requested, the received check image and/or the modified check image may be cropped or the requested data may be extracted from the images. In instances where the check request indicates a particular format for the check, formatting modifications to the one or more check images can be made. For example, the one or more check images and/or the at least one modified check image can be reformatted such that it is compatible with certain software, inserted into a word processing file or spreadsheet file, and/or the data of the one or more check images and/or the at least one modified check image may be converted to text. In other examples, a portion of data of the one or more check images and/or the at least one modified check image is rearranged. For instance, the request may indicate that the payee names, the check numbers, and the paid amount be extracted from the one or more checks and/or the at least one modified check image and be listed in chronological and/or alphabetical order.

In still other embodiments, at least a portion of the one or more check and/or the at least one modified check image is added, deleted, or otherwise modified. In some embodiments, at least some of the previous modifications made to the one or more check images are deleted or removed from the at least one modified check image. For example all or some of the modifications may be removed from the modified check image such that the modified check image is the same or substantially similar to the one or more received check images. By removing some all modifications made to a check image at a later stage, the originally received check image or a check image that is substantially similar to the received check image can be provided. In this way, storage space is dramatically reduced because only a single or a fewer number of check image files are stored than would be necessary if the one or more received check images and modified versions of the one or more received check images were stored. In further embodiments, additional modifications are made to the one or more check images and/or the at least one modified check image. For example, additional data may be added as described herein, adjustments in quality may be implemented, or formatting may be addressed as also described hereinabove. In other embodiments, at least a portion of the one or more remodified check images are stored in the storage device.

As illustrated at block 412, at least a portion of the received one or more received check images, the at least one modified check image, and/or the one or more remodified check images are provided to a recipient. As detailed hereinabove, any portion of the received one or more check images, the at least one modified check image, and/or the one or more remodified check images may be provided to any number or types of recipients via any number of different forms of communications. In some embodiments, at least a portion of the received one or more received check images, the at least one modified check image, and/or the one or more remodified check images are provided to a recipient based on a check request and/or a tag associated with the document.

In some embodiments, a transaction ID, a document ID, or other tag may be included in or associated with one or more received check images, the at least one modified check image, and/or the one or more remodified check images. Details concerning tagging records can be found in, and whereby this application incorporates by reference in its entirety, the following application filed concurrently herewith: U.S. application Ser. No. 13/768,881, entitled IMAGE RETRIEVAL AND TRANSACTION ID CAPTURE filed Feb. 15, 2013 to Michael G. Smith, et al (Atty. Dkt. No. 5511US1.014033.1852). Based on the tag, different versions of the one or more received check images may be restricted or enabled. For example, the remodification may be based at least partially on a tag associated with the check. The tag may indicate that certain portions of the modified check should or should not be included in a check that is provided to a certain recipient. Based on the tag, the one or more received checks or the at least one modified check may be remodified to remove certain layers of modifications. In some examples, only certain versions of a loan document having no modification or only certain modifications may be viewed by one of the parties to a loan document, or by someone who is not a party to the loan document. In other examples, redacted portions of a financial record may not be provided to a customer. In this way, the various versions of check images or other financial records are secured. The processes of FIGS. 4-5 are further described and incorporated in the process of FIG. 5 below.

Referring now to FIG. 5, a process 500 for modifying financial records is illustrated in accordance with some embodiments of the disclosure. Although a single check is illustrated in FIG. 5, it will be understood that any number of checks or other financial records can be used in the process 500. As illustrated at block 502, a check is received. In some embodiments, the check comprises a paper record. In additional or alternative embodiments, the check includes an electronic version of the check or the check data.

As illustrated at block 504, an image of the received check is captured. For example a merchant or financial institution may receive a paper check from a customer and may capture an image of the paper check using a capture device (e.g., camera, scanner, mobile device, and so forth). In some embodiments one or more images of a portion or the entire front of the check and/or a portion or the entire back of the check is captured. In cases where the received check is in electronic form, capturing the image of the received check may not be performed. In other cases where the received check is in electronic form, the file containing the received check may be reformatted or the file may be saved as a different type of file if the received check file is incompatible with the system of process 500 or if the received check file is not in the ideal format.

As illustrated at block 506, errors, updates, repairs, and/or amendments associated with the received check or captured check image are identified. As described hereinabove, any number of errors, updates, repairs, and/or amendment can be identified for a financial record file, such as the check image of process 500. In additional embodiments, errors, updates, repairs, and/or amendments are also identified for the received check. For example, physical damage to the received check such as water damage, paper tears, torn or missing parts, wrinkles, and any damage that is associated with the quality or integrity of the paper or the printed text on the surface of the paper may be identified. In further embodiments, the errors, updates, repairs, and/or amendments discussed above with regard to a financial record file can also be identified in the received check.

As illustrated at block 508, the check image and/or received check are modified based on the identification. As described hereinabove, any number of modifications to address errors, updates, repairs, and/or amendment can be implemented for a financial record file, such as the check image of process 500. In some cases, physical damage, errors, updates, repairs, and/or amendments to the received check is corrected in the electronic version of the received check. For example, shadows, lines, ink smears, torn edges, and/or errors in the data may be corrected in the check image using software capable of addressing such issues. In other cases, physical correction to the check is undertaken. Exemplary physical modifications of the received check include adding or removing information on the front or back surface of the received check, crossing out or whiting out specific lines, overlaying certain data on the received check with additional or corrected data, adding text or images (e.g., printing an endorsement on the back of the received check with ink or gluing an identification photograph to the received check), smoothing out wrinkled paper, repairing water damage, repairing torn paper, binding additional papers to the received check (e.g., gluing, stapling, or taping), producing a raised seal on the received check or associated additional pages, and the like.

As illustrated at block 510, an image of the modified check image and/or modified check is captured. In some embodiments, where there are multiple modifications made to the check image or the received check, an image is captured for each modification. For example, every time a modification is made, an image of the received check is captured or the check image is saved as another file or another version of the same file. In other embodiments, the modifications to the check image are captured and/or saved separately. For example, in cases where a series of numbers (e.g., an endorsement) are overlaid on a portion of the back image of the check, the file containing the series of numbers may be captured and saved separately from the modified check image. Thus, a modification template or modification file containing only the modification that is made to at least a portion of the check image is saved, and the modified check image is also saved.

In additional or alternative embodiments, where there are one or more modifications to the check image and/or modified check, a single image is captured for all of the one or more modifications. For example, an image of the received check is not made until all of the modifications to the received check are implemented. Further, in a check image example, either all of the modifications are saved in the check image file, or all of the modifications are saved as a new file or a new version of the file that is separate from the check image. Each modification to the check image may also be captured and saved as a separate file apart from the single image as discussed above.

As illustrated at block 512, at least a portion of the received check image and/or modified check image is stored in a storage device. To save storage space, in some cases, only one or more modified check images or portions thereof are stored. In other examples, only the portions of the modified check image that are modified may be stored. In still other examples, the entire received check image and/or modified check image is stored. In some embodiments, the portion of the received check image and/or the modified check image to be stored is based on the type of check, the paid amount, the deposited amount, the payee, the payor, the account number associated with the received check, user preferences, legal requirements, internal policies, dates, and the like. For example, the entire front check image and the entire back check image may be stored for received checks having deposit or paid amounts of over $500 or deposit or paid amount that are greater than, less than, or equal to 25% of a user's account balance. In other examples, only certain portions of certain checks having predetermined account numbers are stored. Certain accounts, for example, may have user preferences that include storing only the handwritten portions of the received check that have been enlarged, while the un-modified portions of the check may not be stored. In still other examples, the date of the check can indicate whether or not the received check image or the modified check image should be saved. Legal requirements or internal policies, for example, may indicate that the received check or received check image need only be kept on file for two weeks after the check is received.

As illustrated at block 514, the received check image and/or modified check image is remodified. In some embodiments, the remodification includes a second set of one or more modifications or any modifications that occurs after the first modification. In additional embodiments, as described above with regard to FIG. 4, the remodification is implemented in response to a check request. In other embodiments, the remodification comprises overlaying at least a portion of the received check image with at least a portion of the modified check image, or overlaying the modified check image with additional modifications. For example, in cases where one or more modifications were made to the received check image and saved as separate images or files in the storage device, at least a portion of the one or more modifications may be overlaid onto, embedded in, fused with, or otherwise incorporated into the received check image and/or one of the modified check images. In further embodiments, the remodification is made to the received check image and/or modified check image using software.

As illustrated at block 516, a check request is received. As described above, the request includes, inter alia, an indication of the portion of the received financial record file and/or modified financial record file that is requested, the format of the received financial record file and/or modified financial record file, and/or additional modifications to be made to the received financial record file and/or modified financial record file. In some embodiments, the check request is received from a merchant, a party to the financial record, an account holder associated with the financial record, a third party, a financial institution, a government entity, combinations thereof, and the like.

As illustrated at block 518, at least a portion of the received check image, the modified check image, and/or the remodified check image is provided to a recipient. As detailed herein, any portion of the received one or more check images, the at least one modified check image, and/or the one or more remodified check images may be provided to any number or types of recipients via any number of different forms of communications.

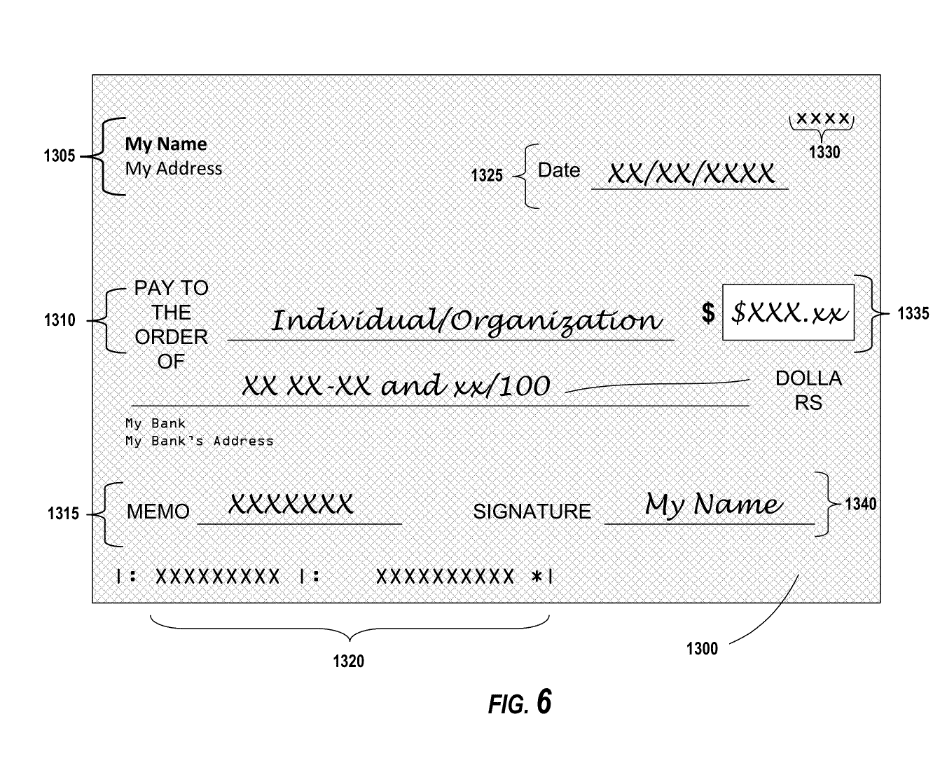

Referring now to FIG. 6, an exemplary image of a check 1300 is illustrated. The image of check 1300 may comprise an image of the entire check, a thumbnail version of the image of the check, individual pieces of check information, or the like. Check 1300 comprises check information, wherein the check information comprises contact information 1305, the payee 1310, the memo description 1315, the account number and routing number 1320 associated with the appropriate user or customer account, the date 1325, the check number 1330, the amount of the check 1335, the signature 1340, or the like. In some embodiments, the check information may comprise text. In other embodiments, the check information may comprise an image. A capture device (e.g., the user's capture device 112 of FIG. 2) may capture an image of the check 1300 and transmit the image to a system of a financial institution (e.g., the financial institution system 132 of FIG. 2) via a network. The system may collect the check information from the image of the check 1300 and store the check information in a datastore (e.g., the datastore 254 of FIG. 2). In some embodiments, the pieces of check information may be stored in the datastore individually. In other embodiments, multiple pieces of check information may be stored in the datastore together. In some embodiments, the pieces of check information may be stored in the datastore immediately following the capture of the image of the check 1300. In other embodiments, the pieces of check information may be stored in the datastore at a predetermined point in time after the image of the check 1300 has been captured. The entity may reserve the right to determine the point in time in which the check information is stored in the datastore. In some embodiments, the check information may be captured or stored in the datastore at a lower resolution than the original image of the check. In other embodiments, the check information may be captured or stored in the datastore at a higher resolution than the original image of the check. In some embodiments, the check information may be captured or stored in the datastore at a reduced size. In other embodiments, the check information may be captured or stored in the datastore at an increased size.

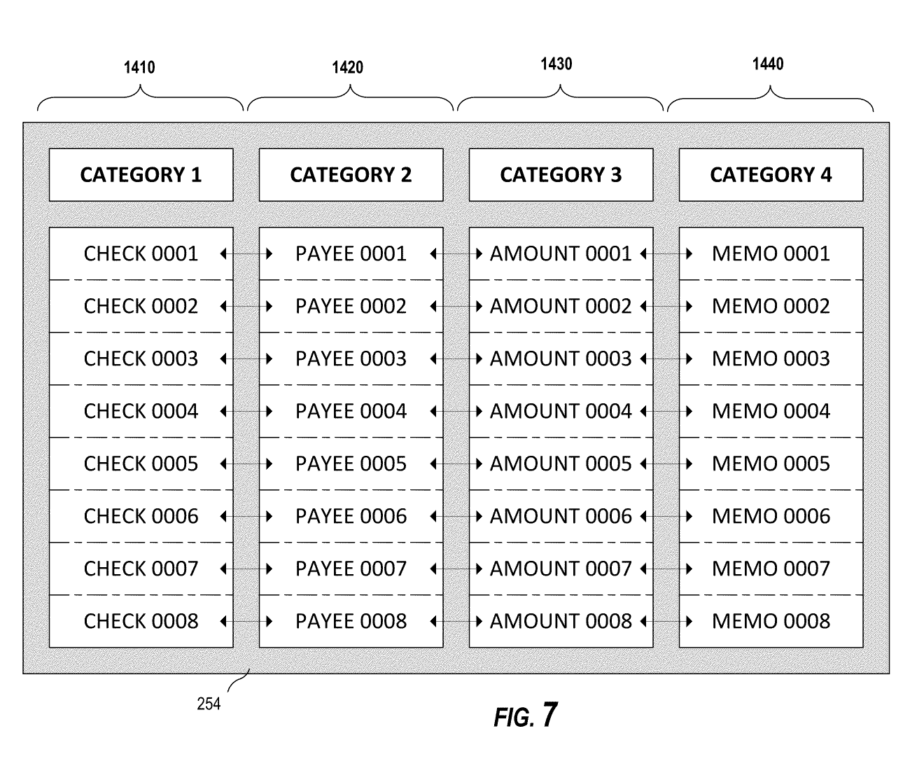

Now referring to FIG. 7, FIG. 7 illustrates an example of a datastore (e.g., the datastore 254 of FIG. 2). A system (e.g., the financial institution system 132 of FIG. 2) may store the pieces of check information of the processed check in one or more datastores. In some embodiments, the datastore 254 may comprise at least one element of check information for multiple checks. For example, the datastore 254 may include check numbers (or payee names, check amounts, check dates, signatures, or the like) for multiple checks. In other embodiments, multiple checks may share a single datastore for the storage of their check information. Items 1410, 1420, 1430, and 1440 represent categories of check information in the datastore 254. For example, categories of check information may include but are not limited to the check number, the payee, the amount of the check, the memo description, the contact information, the date, the signature, the account number and routing number, or the like. Further, associated pieces of check information for a single check may be linked with one another using data or metadata. For example, check number 0001 and payee name 0001 may be associated with each other for ease of access.

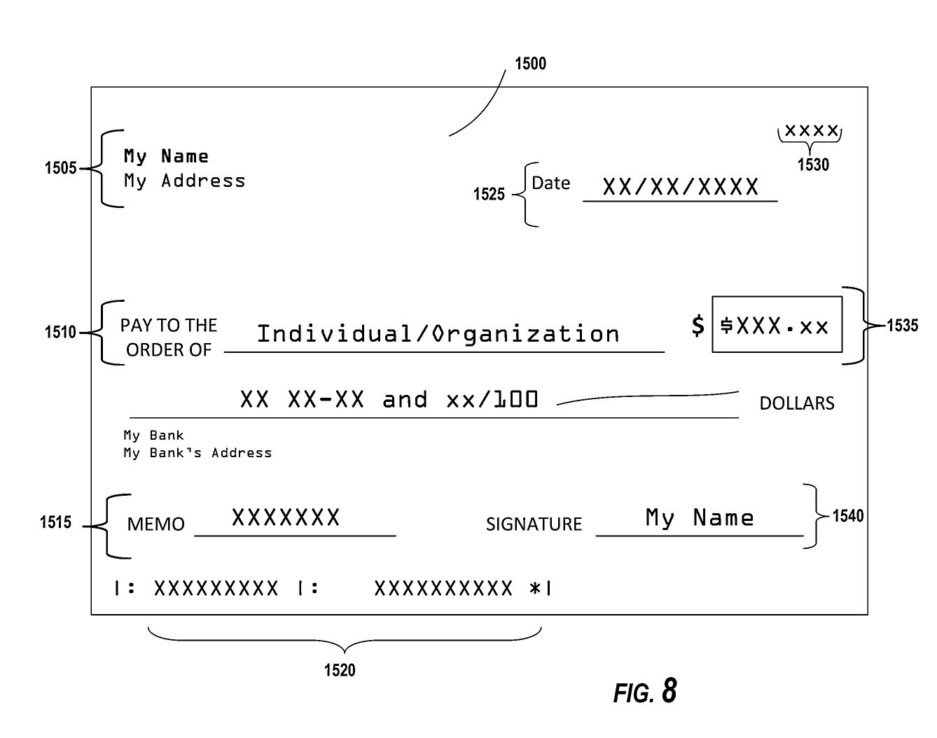

Referring now to FIG. 8, FIG. 8 illustrates an image of a check 1500. The image of the check 1500 comprises an image of the entire check, a thumbnail version of the image of the check, individual pieces of check information, or the like. A system (e.g., the financial institution system 132 of FIG. 2) may retrieve the pieces of check information to generate a new image of the check 1500. In some embodiments, the retrieved pieces of check information may be presented in the image of the check 1500 at a lower resolution than the original image of the check. In other embodiments, the check information may be presented in the image of the check 1500 at a higher resolution than the original image of the check. In some embodiments, the check information may be presented in the image of the check 1500 at a reduced size. In other embodiments, the check information may be presented in the image of the check 1500 at an increased size. The check 1500 may comprise check information, wherein the check information may comprise contact information 1505, the payee 1510, the memo description 1515, the account number and routing number 1520 associated with the appropriate user or customer account, the date 1525, the check number 1530, the amount of the check 1535, the signature 1540, or the like. Although only the front portion of the check is shown in the illustrated embodiments, it will be understood that images of the front and back portions of the check can also be captured and that any data on the front and back portions of the check can be used and stored.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

What is claimed is:

1. A system for modifying financial records, the system comprising:
a computer apparatus including a processor and a memory; and
a modification software module stored in the memory, comprising executable instructions that when executed by the processor cause the processor to:
receive financial record data;
identify one or more criteria associated with the financial record data;
quantify the size of the one or more criteria;
modify at least a portion of the financial record data based on size of the one or more criteria;
store at least one of the received financial record data and one or more modified portions of the financial record data in a storage device; and
provide at least a portion of the received financial record data or modified financial record data to a recipient.

2. The system of claim 1, wherein the received financial record data comprises at least one of a financial record image and a financial record, wherein the financial record comprises a paper record.

3. The system of claim 2, wherein the modification comprises modification to a front portion of the financial record or the back portion of the financial record.

4. The system of claim 2, wherein the module is further configured to:
capture one or more images of the financial record and one or more images of the one or more modified portions.

5. The system of claim 4, wherein the module is further configured to:
overlay the financial record image with the one or more modified images.

6. The system of claim 5, wherein the module is further configured to:
remove the one or more modified images from the received financial record image.

7. The system of claim 1, wherein the one or more criteria comprises at least one of errors, repairs, updates, and amendments.

8. The system of claim 1, wherein the size of the one or more criteria comprises a total number or a quality level of the errors, the repairs, the updates, or the amendments.

9. The system of claim 1, wherein the module is further configured to:
add or remove at least a portion of the financial record data.

10. The system of claim 1, wherein the module is further configured to:
receive a financial record request; and
remodify at least one of the received financial record data and the one or more modified portions of the financial record data based on the financial record request.

11. The system of claim 1, wherein the financial record comprises a check.

12. The system of claim 1, wherein the modification comprises at least one of a physical modification to a paper record and an electronic modification to electronic data.

13. A computer program product for modifying financial records, the computer program product comprising:
a computer readable storage medium having computer readable program code embodied therewith, the computer readable program code comprising:
computer readable program code configured to receive financial record data;
computer readable program code configured to identify one or more criteria associated with the financial record data;
computer readable program code configured to quantify the size of the one or more criteria;
computer readable program code configured to store at least one of the received financial record data and one or more modified portions of the financial record data in a storage device; and
computer readable program code configured to modify at least a portion of the financial record data based on the size of the one or more criteria; and
computer readable program code configured to provide at least a portion of the received financial record data or modified financial record data to a recipient.

14. The computer program product of claim 13, wherein the received financial record data comprises at least one of a financial record image and a financial record, wherein the financial record comprises a paper record.

15. The computer program product of claim 14, further comprising computer readable program code configured to
store at least one of the received financial record data and one or more modified portions of the financial record data in a storage device;
capture one or more images of the financial record and one or more images of the one or more modified portions; and
overlay the financial record image with the one or more modified images.

16. The computer program product of claim 13, wherein the one or more criteria comprises at least one error, repair, update, and amendment.

17. A computer-implemented method for modifying financial records, the method comprising:
receiving, at a computing device, financial record data;
identifying, by a computing device processor, one or more criteria associated with the financial record data;
quantifying, by a computing device processor, the size of the one or more criteria;
modifying, by a computing device processor, at least a portion of the financial record data based on size of the one or more criteria;
storing, by a computing device processor, at least one of the received financial record data and one or more modified portions of the financial record data in a storage device; and
providing at least a portion of the received financial record data or modified financial record data to a recipient.

18. The method of claim 17, wherein the one or more criteria comprises at least one error, repair, update, and amendment.

19. The method of claim 17, wherein the size of the one or more criteria comprises a total number or a quality level of the at least one error, the at least one repair, the at least one update, or the at least one amendment.

20. The method of claim 17, further comprising:
receiving a financial record request; and
remodifying, by a computing device processor, at least one of the received financial record data and the one or more modified portions of the financial record data based on the financial record request.
